(19) United States
(12) Patent Application Publication
(10) Pub. No.: US 2012/0312782 A1
(43) Pub. Date: Dec. 13, 2012

(54) ETCHING METHOD AND ETCHING DEVICE

(75) Inventor: Junichi Tanaka, Osaka (JP)

(73) Assignee: SHARP KABUSHIKI KAISHA, Osaka (JP)

(21) Appl. No.: 13/578,720

(22) PCT Filed: Nov. 16, 2010
(86) PCT No.: PCT/JP2010/006706

§ 371 Date: Aug. 13, 2012

(30) Foreign Application Priority Data
Feb. 18, 2010 (JP) 2010-033806

(51) Int. Cl. C23F 1/14; B05B 1/00

(52) U.S. Cl. 216/92; 216/95; 156/345.21

(57) ABSTRACT

A metal film (17) is etched by having an etching solution (5) sprayed to an object to be processed (48) having the metal film formed on a surface of a substrate (4). The etching solution (5) that contains gas micro-nano bubbles (40) having negative zeta potential is sprayed onto a surface of the metal film (17), removing a metal oxide (30) having positive zeta potential formed thereon.

### TECHNICAL FIELD

The present invention relates to an etching method of etching a metal film formed on a substrate, for example, and an etching device.

### BACKGROUND ART

Conventionally, in a display device such as a liquid crystal display device or an organic EL display device, pixels arranged on a glass substrate in a matrix are controlled by transistors arranged near the pixels, for example. For such transistors, thin film transistors (TFTs) made of an amorphous silicon thin film or a polysilicon thin film have been used to control the pixels.

Photolithography is an indispensable process for forming elements such as the TFTs (thin film transistors) and colored layers of a color filter in a prescribed pattern on a substrate that constitutes a liquid crystal display panel, for example.

After a resist is applied on a semiconductor layer, and a resist pattern is formed by a typical photolithography process, for example, the semiconductor layer exposed from the resist pattern is removed by etching. Thereafter, the unnecessary resist is removed, and a prescribed pattern is formed. As described, a cycle of applying the resist, forming the resist pattern, etching, and removing the resist is repeated, thereby forming circuits and wiring on a substrate.

As a conventional etching method, wet etching, in which an object to be processed is immersed in a prescribed chemical solution (etching solution) and dissolved by a chemical reaction, has been employed. In such wet etching, the etching solution and the object to be processed react chemically, initiating a dissolution reaction on a surface of the object to be processed and forming a reaction product thereon. Therefore, in order to diffuse and remove the reaction product, the etching solution, which is in contact with the object to be processed, needs to be agitated. If the etching solution is not agitated, it causes a problem of slowing down the etching process on the surface of the object to be processed.

In this case, if the wet etching is continued when the reaction product is formed on the surface of the object to be processed, irregularities are formed on the surface of the object to be processed, resulting in an uneven thickness.

In order to prevent such a problem, the etching solution needs to be agitated so as to create a flow, thereby diffusing and removing the reaction product from the surface of the object to be processed, which allows the etching to proceed evenly on the entire surface of the object to be processed.

A technique for evenly agitating the etching solution has been disclosed so as to prevent these problems. More specifically, an etching device includes an etching bath that contains an etching solution, in which an object to be processed is immersed for etching, a diffuser unit that is provided in the etching bath and that generates bubbles of moisture-containing gas so as to agitate the etching solution, and a diffuser member that is provided in the diffuser unit and that has a number of small holes for supplying bubbles of the moisture-containing gas to the etching solution has been disclosed.

It is described that when this etching device is used, a gas that passes through the small holes in the diffuser member of the diffuser unit is moisturized, and therefore, drying of the small holes is prevented. As a result, clogging of the small holes due to condensation of the etching solution on inside surfaces of the small holes can be prevented, which makes it possible to generate the bubbles nearly evenly from the entire diffusion surface of the diffuser member and to thereby agitate the etching solution evenly (see Patent Document 1, for example).

### RELATED ART DOCUMENT

### Patent Document

Patent Document 1: Japanese Patent Application Laid-Open Publication No. 2008-147637

### SUMMARY OF THE INVENTION

### Problems to be Solved by the Invention

The conventional etching method described above, however, had the following problems. The conventional etching method employs a method of facilitating the diffusion of the reaction product by creating a flow of the etching solution so as to remove the reaction product formed on the surface of the object to be processed. The reaction product on the surface of the object to be processed, however, cannot be completely removed in this way. This made it difficult to allow the etching to proceed evenly on the entire surface of the object to be processed, and a slowdown of the etching speed occurred.

Particularly, the etching speed tends to be varied depending on a shape of the object to be processed, which is an object of etching, an arrangement of the object to be processed in the etching bath, or the like. This made it difficult to allow the etching to proceed evenly on the entire surface of the object to be processed.

The present invention was made in view of the problems described above, and its object is to provide an etching method and an etching device that can allow etching to proceed evenly on the entire surface of the object to be processed and that prevents the etching speed from slowing down.

### Means for Solving the Problems

In order to achieve the object described above, an etching method of the present invention is an etching method of etching a metal film by spraying an etching solution to an object to be processed having the metal film formed on a surface of a substrate, the method comprising spraying the etching solution containing gas micro-nano bubbles having negative zeta potential to remove metal oxide having positive zeta potential formed on the surface of the metal film.

According to this configuration, when the metal film is etched using the etching solution having the gas micro-nano bubbles mixed therein, the micro-nano bubbles mixed in the etching solution absorb the metal oxide, which is a reaction product, thereby carrying away and separating the metal oxide from the surface of the metal film. Therefore, the metal oxide can be completely removed from the surface of the metal film. Consequently, it becomes possible to constantly supply a fresh etching solution to the surface of the metal film, which is the object of etching. As a result, it becomes possible to allow etching to proceed evenly on the entire surface of the metal film, and a slowdown of the etching speed can also be prevented.

In the etching method of the present invention, the gas may be air.

According to this configuration, micro-nano bubbles of air can be used. Therefore, etching can be performed using environment-friendly micro-nano bubbles.

In the etching method of the present invention, hydrogen peroxide water may be used as the etching solution, and a copper film may be used as the metal film.

In the etching method of the present invention, a diameter of the micro-nano bubbles may be 0.01 μm or more and 100 μm or less.

According to this configuration, the micro-nano bubbles can immediately reach the surface of the metal film, and easily enter fine gaps in a pattern of a resist layer formed on the surface of the metal film. Therefore, even when a fine pattern is to be formed on the metal film by etching, it becomes possible to allow the etching to proceed evenly on the entire surface of the metal film, and a slowdown of the etching speed caused by the formation of the metal oxide can be reliably prevented.

In the etching method of the present invention, the metal film may be etched while the object to be processed is moved.

According to this configuration, it becomes possible to evenly spray the etching solution containing the gas micro-nano bubbles to the entire surface of the metal film. This allows the etching to proceed more evenly on the surface of the metal film, and a slowdown of the etching speed can be prevented even more reliably.

An etching device of the present invention is provided with a generation unit that generates the etching solution that contains gas micro-nano bubbles having negative zeta potential, a nozzle header provided with a spray nozzle that sprays the etching solution supplied from the generation unit, and a holder that supports the object to be processed having the metal film formed on the surface of the substrate such that the object to be processed faces the nozzle header. When the etching solution is sprayed to the object to be processed, the metal film is etched and the metal oxide having positive zeta potential that is formed on the surface of the metal film is removed.

According to this configuration, when the metal film is etched using the etching solution having gas micro-nano bubbles mixed therein, the micro-nano bubbles mixed in the etching solution absorb the metal oxide, which is a reaction product, thereby carrying away and separating the metal oxide from the surface of the metal film. Therefore, the metal oxide can be completely removed from the surface of the metal film. Consequently, it becomes possible to constantly supply a fresh etching solution to the surface of the metal film, which is the object of etching. As a result, it allows the etching to proceed evenly on the entire surface of the metal film, and a slowdown of the etching speed can be prevented.

In the etching device of the present invention, the gas may be air.

According to this configuration, micro-nano bubbles of air can be used. Therefore, etching can be performed using environment-friendly micro-nano bubbles.

In the etching device of the present invention, hydrogen peroxide water may be used as the etching solution, and a copper film may be used as the metal film.

In the etching device of the present invention, a diameter of the micro-nano bubbles may be 0.01 μm or more and 100 μm or less.

According to this configuration, the micro-nano bubbles can immediately reach the surface of the metal film, and easily enter fine gaps in a pattern of a resist layer formed on the surface of the metal film. Therefore, even when a fine pattern is to be formed on the metal film by etching, it becomes possible to allow the etching to proceed evenly on the entire surface of the metal film, and a slowdown of the etching speed caused by the formation of the metal oxide can be reliably prevented.

In the etching device of the present invention, the holder may be configured to move the object to be processed while maintaining a state in which the etching solution is sprayed to the object to be processed.

According to this configuration, it becomes possible to evenly spray the etching solution containing the gas micro-nano bubbles to the entire surface of the metal film. Therefore, it becomes possible to allow the etching to proceed more evenly on the surface of the metal film, and a slowdown of the etching speed can be prevented even more reliably.

### Effects of the Invention

According to the present invention, it becomes possible to allow etching to proceed evenly on the entire surface of the metal film, and a slowdown of the etching speed can be prevented.

### BRIEF DESCRIPTION OF THE DRAWINGS

FIG. 1 is a schematic view showing an overall configuration of an etching device to which an etching method according to an embodiment of the present invention is applied.

FIG. 2 is a plan view showing the overall configuration of the etching device to which the etching method according to an embodiment of the present invention is applied.

FIG. 3 is an explanatory diagram for a configuration of a holder in the etching device to which the etching method according to an embodiment of the present invention is applied.

FIG. 4 is a flow chart for explaining the etching method according to an embodiment of the present invention.

FIG. 5 is a figure showing a reaction product formed deposited on a surface of an object to be processed.

FIG. 6 is an explanatory diagram for a method of making an etching solution flow so as to facilitate diffusion and removal of the reaction product.

FIG. 7 is an explanatory diagram for a method of removing the reaction product by micro-nano bubbles in the etching method according to an embodiment of the present invention.

FIG. 8 is an explanatory diagram for a relationship between zeta potential and pH.

### DETAILED DESCRIPTION OF EMBODIMENTS

An embodiment of the present invention will be described below in detail with reference to figures.

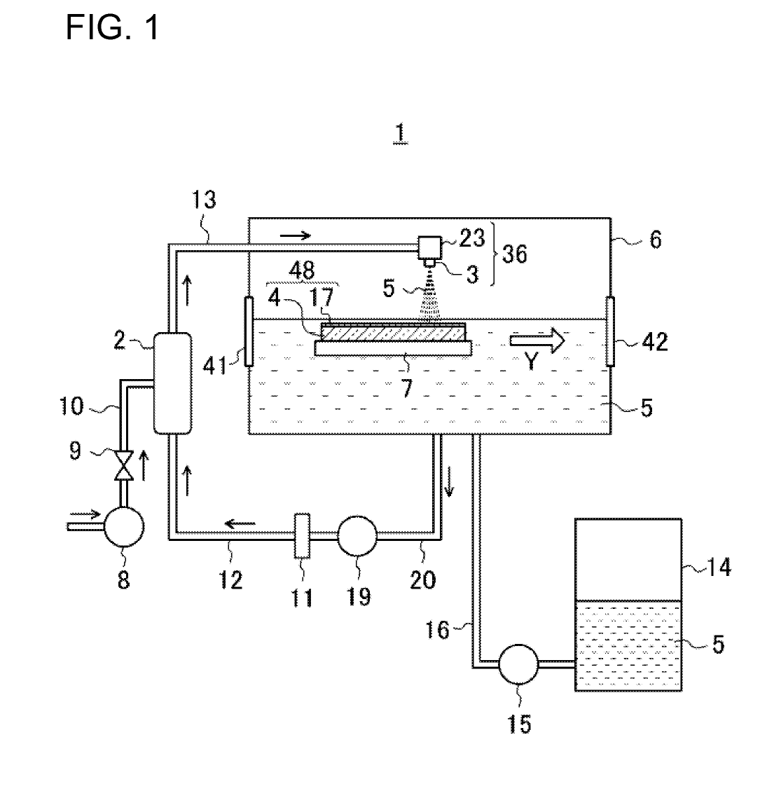

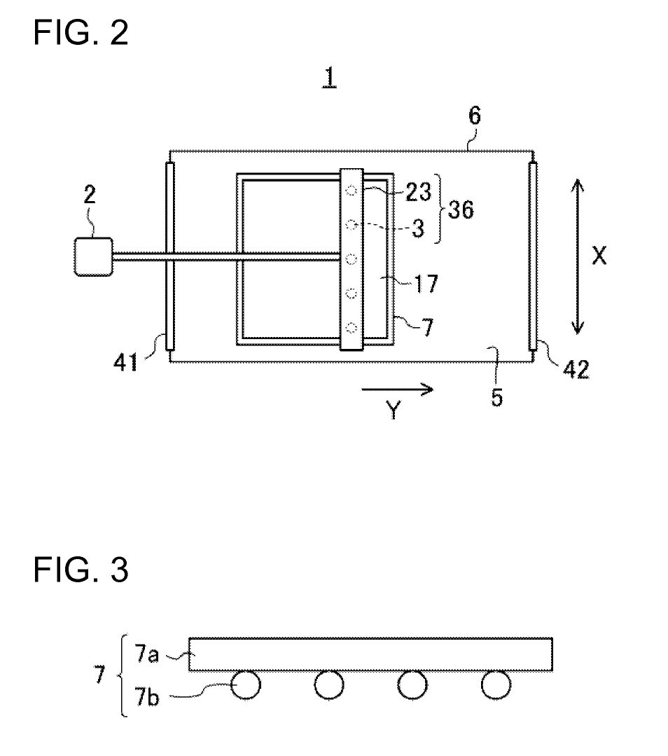

FIG. 1 is a schematic view showing an overall configuration of an etching device to which an etching method according to an embodiment of the present invention is applied. FIG. 2 is a plan view showing the overall configuration of the etching device to which the etching method according to the embodiment of the present invention is applied. FIG. 3 is an explanatory diagram for a configuration of a holder in the etching device to which the etching method according to the embodiment of the present invention is applied.

As shown in FIG. 1, an etching device 1 in the present embodiment is provided with an etching solution generation unit (hereinafter referred to as a “generation unit”) 2 that generates an etching solution having gas micro-nano bubbles mixed therein and a nozzle header 36 that is provided with spray nozzles 3 to spray an etching solution 5 that has the micro-nano bubbles mixed therein and that is supplied from the generation unit 2 to an object to be processed 48.

The etching device 1 includes an etching bath 6 that stores the etching solution 5, in which the object to be processed 48 is immersed for etching, and a holder 7 that is a substrate support portion for supporting the object to be processed 48 such that the object to be processed 48 faces the spray nozzles 3. The spray nozzles 3 and the holder 7 are provided inside the etching bath 6.

The micro-nano bubbles here refer to bubbles with a diameter of 0.01 μm or more and 100 μm or less. Further, air micro-nano bubbles refer to micro-nano bubbles in which a gas constituting the bubbles is air.

A solution with air micro-nano bubbles refers to an etching solution that contains the air micro-nano bubbles. A density of the air micro-nano bubbles in the solution with air micro-nano bubbles is 1000 or more and 100000 or less bubbles per 1 ml.

As shown in FIG. 1, the etching bath 6 is provided with a carrying-in gate 41 for carrying the holder 7 that supports the object to be processed 48 into the etching bath 6, and a carrying-out gate 42 for carrying the holder 7 out of the etching bath 6.

As shown in FIG. 1, an air compressor 8 is connected to the generation unit 2. The air compressor 8 is connected to the generation unit 2 by a pipe 10 that is provided with an opening and closing valve 9.

As shown in FIG. 1, the etching device 1 is provided with a circulation pump 19 for circulating the etching solution 5 in the etching bath 6. An inlet of the circulation pump 19 is connected to a bottom of the etching bath 6 by a pipe 20.

As shown in FIG. 1, the circulation pump 19 is connected to the generation unit 2. The circulation pump 19 is connected to the generation unit 2 by a pipe 12 provided with a filter 11 for removing foreign objects existing in the circulating etching solution 5.

As shown in FIG. 1, the generation unit 2 is connected to the spray nozzles 3 of the nozzle header 36. The generation unit 2 is connected to the spray nozzles 3 by a pipe 13 for supplying, to the spray nozzles 3, the etching solution having the gas micro-nano bubbles mixed therein, which is generated by the generation unit 2.

The etching device 1 of the present embodiment is also provided with an etching solution storing bath 14 that stores the etching solution 5 to be supplied to the etching bath 6.

This etching solution storing bath 14 is connected to the etching bath 6 by a pipe 16 provided with a supply pump 15 for supplying the etching solution 5 in the etching solution storing bath 14 to the etching bath 6.

The etching solution storing bath 14 is provided for adjusting a level of the etching solution 5 in the etching bath 6.

The generation unit 2 is configured to generate the solution with the air micro-nano bubbles by a so-called pressure dissolution method.

In the pressure dissolution method, using Henry's Law, bubbles are generated by dissolving a gas into a liquid under a pressure, and by thereafter depressurizing and releasing the liquid That is, the air compressed by the air compressor 8 is supplied to the generation unit 2 through the pipe 10 while the opening and closing valve 9 is opened.

Then, in the generation unit 2, the air is pressure-dissolved into the etching solution 5 that was supplied to the inside of the generation unit 2 by the circulation pump 19, and the air micro-nano bubbles are generated.

The solution with the air micro-nano bubbles in the generation unit 2 is supplied to the spray nozzles 3 through the pipe 13. Then, the object to be processed 48 is etched by spraying the solution with the air micro-nano bubbles from the spray nozzles 3 to a metal film 17 of the object to be processed 48.

The pressure dissolution method is employed here as a method of generating the micro-nano bubbles, but the method is not limited to such. Other than the pressure dissolution method, an ultrahigh-speed turning method, a gas-liquid mixing/shearing method, a pore method, an ultrasonic method, or the like, for example, can also be employed.

The object to be processed 48 includes a substrate 4 such as a glass substrate that constitutes a liquid crystal display panel and a metal film (a Cu film that forms source electrodes of TFTs and the like, for example) 17, which is the object of etching, formed on a surface of the substrate 4, for example.

As shown in FIGS. 1 and 2, on a surface of the object to be processed 48 that faces the spray nozzles 3, the metal film 17, which is the object of etching, is provided.

As shown in FIGS. 1 and 2, the holder 7 is configured to move the object to be processed 48 in a prescribed direction (direction shown by an arrow Y in FIGS. 1 and 2), while maintaining a prescribed distance between the object to be processed 48 and the nozzle header 36.

As shown in FIG. 3, the holder 7 may be constituted of a belt 7a on which the object to be processed 48 is placed and a plurality of rollers 7b that move the belt 7a, for example. Here, the speed of carrying the object to be processed 48 is 1000 mm/min or more and 10000 mm/min or less, for example.

The nozzle header 36 is arranged and fixed above the holder 7, and has a header body 23 and a plurality of spray nozzles 3 provided under the header body 23. The header body 23 is supplied with the solution with air micro-nano bubbles, which is generated by the generation unit 2, through the pipe 13.

As shown in FIGS. 1 and 2, a plurality of spray nozzles 3 are arranged in line. The arrangement direction of the spray nozzles 3 is a direction orthogonal to a moving direction Y of the object to be processed 48 (in other words, the width direction X of the object to be processed 48).

The spray nozzles 3 are made to spray the etching solution 5 having the gas (air) micro-nano bubbles mixed therein in a direction perpendicular to the surface of the object to be processed 48.

In the present embodiment, an inner diameter of the respective spray nozzles 3 is set to 0.05 mm or more and 0.5 mm or less. This makes it possible to prevent clogging of the spray nozzles 3, and to achieve a suitable velocity of the solution with the air micro-nano bubbles for etching the metal film 17 provided on the object to be processed 48. Further, the injection amount of the solution with the air micro-nano bubbles in the spray nozzles 3 is 0.5 ml/cm²·sec or more and 100 ml/cm²·sec or less.

As described above, the etching device 1 is configured to etch the metal film 17 that is formed on the surface of the object to be processed 48 by spraying the solution with the air micro-nano bubbles from the plurality of spray nozzles 3 in the nozzle header 36 to the object to be processed 48 supported by the holder 7.

Next, an etching method of etching the object to be processed 48 by the etching device 1 will be described, together with a photolithography process and a resist removing process that are performed respectively before and after the etching.

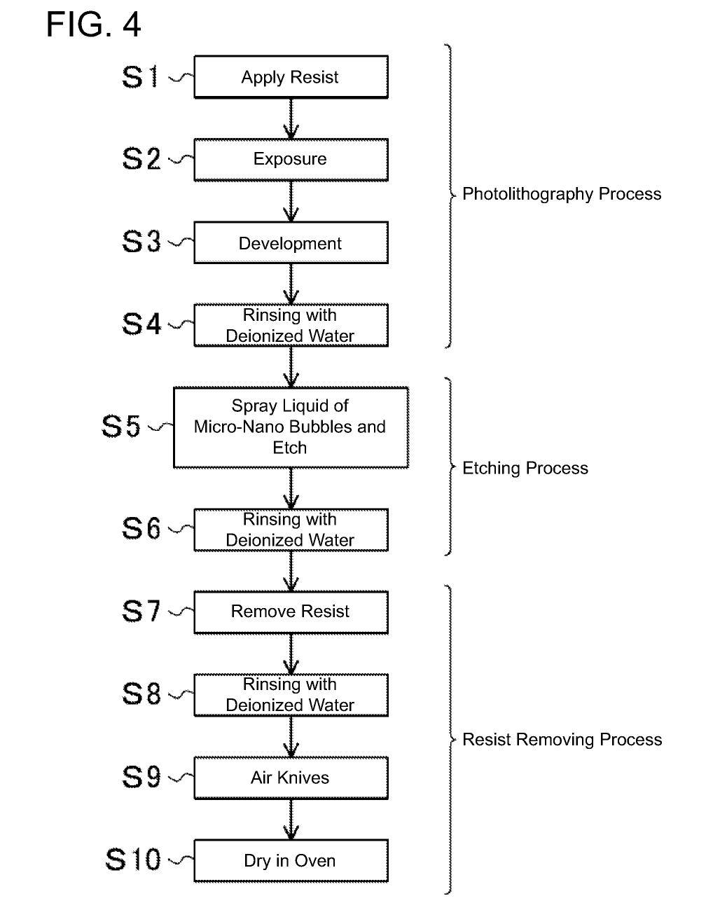

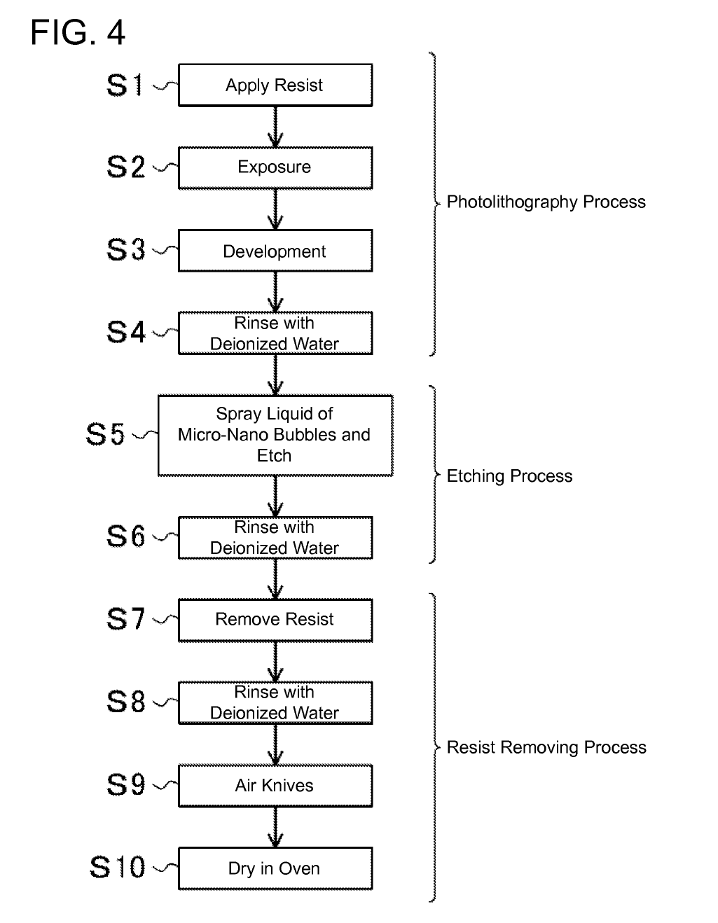

FIG. 4 is a flow chart for explaining the etching method according to an embodiment of the present invention.

In the present embodiment, the following processes are performed: the photolithography process of forming a resist pattern on a surface of a component formed on the object to be processed 48, which is a large glass substrate; the etching process of etching the component exposed from the resist; and the resist removing process of separating and removing the used resist from the object to be processed 48.

In the photolithography process, Steps S1 to S4 in FIG. 4 are performed. First, in Step S1, a resist layer (not shown) is applied and formed on a surface of the metal film 17 that is a component formed on the object to be processed 48. Next, in Step S2, the resist layer undergoes an exposure.

Next, in Step S3, the resist layer after the exposure is developed. Then, in Step S4, the resist layer is rinsed with deionized water shower. By patterning the resist layer in this way, a resist pattern is formed.

Next, in the etching process, Steps S5 to S6 in FIG. 4 are performed. First, in Step S5, the metal film 17 exposed from a resist pattern 29 is etched.

More specifically, a solution with the gas micro-nano bubbles is sprayed and supplied to the object to be processed 48 from the plurality of spray nozzles 3 arranged in line in the direction orthogonal to the moving direction of the object to be processed 48 that has been moved to a position below the nozzle header 36. Then, the metal film 17 that is formed on the surface of the object to be processed 48 is etched.

As described above, the solution with gas micro-nano bubbles is generated by the generation unit 2, and is supplied to the header body 23 of the nozzle header 36 through the pipe 13. Here, the temperature of the solution with gas micro-nano bubbles is set to a room temperature or more and 60° C. or less.

A characteristic feature of the present embodiment is that the metal film 17 is etched in the etching device 1 described above by using the etching solution having the gas micro-nano bubbles mixed therein.

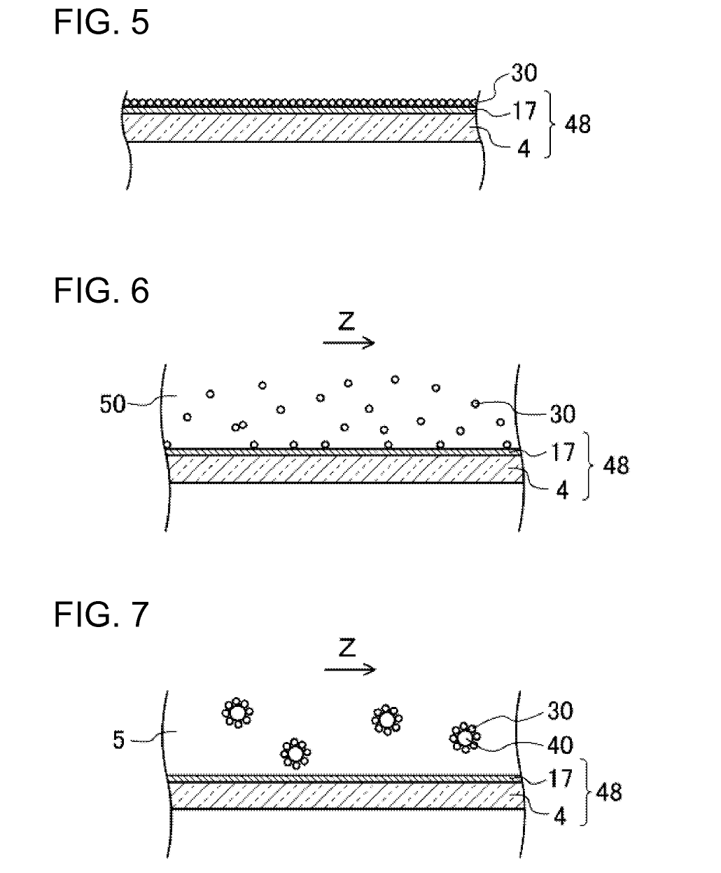

When hydrogen peroxide water (H₂O₂) is used as the etching solution 5 to etch the metal film (Cu film) 17, for example, a component (Cu) of the metal film 17 reacts with components of the etching solution 5, thereby forming a metal oxide (in this case, CuO) 30, which is a reaction product, on the surface of the object to be processed 48 (in other words, on the surface of the metal film 17) as shown in FIG. 5.

If the etching is continued when such a metal oxide 30 is formed on the surface of the object to be processed 48, the metal oxide 30 interferes with the reaction between the etching solution 5 and the metal film 17. Therefore, the metal oxide 30 needs to be removed.

In this case, if a method of removing the metal oxide by creating a flow of the etching solution to facilitate the diffusion thereof is employed, as in the conventional etching method, the following problems would arise. As shown in FIG. 6, the metal oxide 30 can be removed to some extent from the surface of the object to be processed 48 (in other words, the surface of the metal film 17) by the flow (the flow in the direction shown by an arrow Z in FIG. 6) of the etching solution 50. However, the metal oxide 30 cannot be removed completely, and therefore, it becomes difficult to allow the etching to proceed evenly on the entire surface of the object to be processed 48, and the etching speed slows down.

On the other hand, when the metal film 17 is etched in the etching device 1 by using the etching solution 5 having the gas micro-nano bubbles mixed therein as in the present embodiment, the micro-nano bubbles 40 mixed in the etching solution 5 absorb the metal oxide 30, as shown in FIG. 7, thereby carrying away and separating the metal oxide 30 from the surface of the metal film 17.

Therefore, as shown in FIG. 7, the metal oxide 30 can be removed completely from the surface of the metal film 17, and therefore, the fresh etching solution 5 can be constantly supplied to the surface of the metal film 17, which is the object of etching. This allows the etching to proceed evenly on the entire surface of the object to be processed 48, and a slowdown of the etching speed can be prevented.

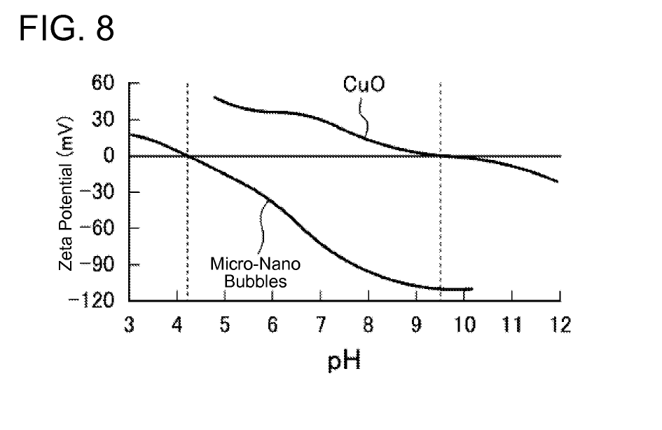

Next, a principle of the micro-nano bubbles 40 absorbing the metal oxide 30 will be described. FIG. 8 is a diagram for explaining a pH dependence of zeta potential of the micro-nano bubbles and CuO, which is an example of the metal oxide.

As shown in FIG. 8, zeta potential of CuO, which is the metal oxide 30, and zeta potential of the micro-nano bubbles 40 are changed depending on pH.

More specifically, it is shown that the zeta potential of CuO, which is the metal oxide 30, is positive (>0) in a range of pH<9.5, and on the other hand, the zeta potential of the micro-nano bubbles 40 is negative (<0) in a range of pH>4.2. Therefore, it is understood that in the range of 4.2<pH<9.5, the micro-nano bubbles 40 can absorb and carry away CuO, which is the metal oxide 30.

In other words, because the micro-nano bubbles 40 have the zeta potential of a reversed polarity of that of the metal oxide 30, when the metal film 17 is etched with the etching solution 5 having the gas micro-nano bubbles 40 mixed therein, the metal oxide 30 is electrically absorbed to the surface of the micro-nano bubbles 40. Therefore, as described above, the micro-nano bubbles 40 can absorb the metal oxide 30, and the metal oxide 30 can be carried away and separated from the surface of the metal film 17.

As described above, because the micro-nano bubbles 40 can reliably remove the metal oxide 30 that is formed on the surface of the object to be processed 48, the etching can be performed evenly on the entire surface of the object to be processed 48, and a slowdown of the etching speed caused by the formation of the metal oxide 30 can be reliably prevented.

Also, variations in the etching speed due to a shape of the object to be processed 48 (i.e., the metal film 17), which is the object of etching, an arrangement of the object to be processed 48 in the etching bath 6, and the like can be effectively minimized, which makes it possible to allow the etching to proceed evenly on the entire surface of the metal film 17.

As described above, each of the micro-nano bubbles 40 is a fine bubble with a diameter of 0.01 μm or more and 100 μm or less. Therefore, the micro-nano bubbles 40 can immediately reach the surface of the metal film 17, and easily enter fine gaps in a pattern of a resist layer.

Therefore, even when a microscopic pattern is to be formed on the metal film 17 by etching, the etching can be performed evenly on the entire surface of metal film 17, and a slowdown of the etching speed caused by the formation of the metal oxide 30 can be reliably prevented.

Here, when the metal film 17 formed on the object to be processed 48 is etched, a plurality of objects to be processed 48 are sequentially conveyed and etched by a so-called single-wafer system.

In the etching device 1 described above, first, the etching solution 5 in the etching bath 6 is transferred to the etching solution storing bath 14 so as to lower the level of the etching solution 5 in the etching bath 6. While the level is low, the carrying-in gate 41 is opened, and the holder 7 that supports the object to be processed 48 is carried into the etching bath 6.

Thereafter, with the carrying-in gate 41 being closed, the etching solution 5 is transferred from the etching solution storing bath 14 to the inside of the etching bath 6 so as to raise the level of the etching solution 5 in the etching bath 6. As a result, the object to be processed 48 is immersed in the etching solution 5.

Next, the level of the etching solution 5 is lowered, and the etching solution 5 having the gas micro-nano bubbles mixed therein is sprayed from the spray nozzles 3 to the surface of the object to be processed 48 (in other words, the surface of the metal film 17), thereby performing the etching while the object to be processed 48 is moved.

After the etching is completed, the carrying-out gate 42 is opened, and the holder 7 that supports the object to be processed 48 is carried out of the etching bath 6. Thereafter, the carrying-out gate is closed, and Step S5 in the etching process is completed.

The surface of the object to be processed 48 does not necessarily need to be immersed in the etching solution 5 before the etching solution 5 is discharged and sprayed from the spray nozzles 3. The level of the etching solution 5 may stay lower than the position of the holder 7 throughout the process, and the etching may be performed only by spraying the etching solution 5 from the spray nozzles 3.

Next, rinsing with deionized water shower is performed in Step S6. This way, the etching process is completed, and the metal film 17 is patterned into a prescribed pattern.

Next, in the resist removing process, first, in Step S7, the resist removal is performed by using a prescribed resist-removing solution, thereby completely removing the resist on the object to be processed 48.

Next, in Step S8, the object to be processed 48 is rinsed with the deionized water shower. Thereafter, in Step S9, the surface of the object to be processed 48 is wiped with compressed air blown from an air knife (not shown) so as to blow off and remove the remaining water droplets on the object to be processed 48.

Next, in Step S10, the object to be processed 48 is transferred into an oven (not shown), and by blowing hot air to the surface of the object to be processed 48, the object to be processed 48 is heated and dried quickly. By performing the respective steps described above, the substrate cleaning is completed.

The following effects can be obtained from the embodiments described above.

(1) In the present embodiment, the etching solution 5 containing the gas micro-nano bubbles 40 having negative zeta potential is sprayed so as to remove the metal oxide 30 having positive zeta potential formed on the surface of the metal film 17. Therefore, when the metal film 17 is etched using the etching solution 5 having the gas micro-nano bubbles 40 mixed therein, the micro-nano bubbles 40 mixed in the etching solution 5 absorb the metal oxide 30, thereby carrying away and separating the metal oxide 30 from the surface of the metal film 17. Thus, the metal oxide 30 can be completely removed from the surface of the metal film 17. Consequently, it becomes possible to constantly supply the fresh etching solution 5 to the surface of metal film 17, which is the object of etching. This allows the etching to proceed evenly on the entire surface of the metal film 17, and a slowdown of the etching speed can also be prevented.

(2) In the present embodiment, air is used as a gas for forming the micro-nano bubbles 40. This allows for a use of the air micro-nano bubbles 40, and therefore, the etching can be performed using the environment-friendly micro-nano bubbles 40.

(3) In the present embodiment, the diameter of the respective micro-nano bubbles is set to 0.01 μm or more and 100 μm or less. Therefore, the micro-nano bubbles 40 can immediately reach the surface of the metal film 17, and easily enter fine gaps in a pattern of a resist layer formed on the surface of the metal film 17. Thus, even when a fine pattern is to be formed on the metal film 17 by etching, etching can be performed evenly on the entire surface of the metal film 17, and a slowdown of the etching speed caused by the formation of the metal oxide 30 can be reliably prevented.

(4) In the present embodiment, because the metal film 17 is etched while the object to be processed 48 is moved, the etching solution 5 containing the gas micro-nano bubbles 40 can be evenly sprayed to the entire surface of the object to be processed 48. This allows the etching to proceed more evenly on the surface of the metal film 17, and a slowdown of the etching speed can be prevented even more reliably.

The above-mentioned embodiment may be modified as follows.

The above-mentioned embodiment is configured to use air as a gas for forming the micro-nano bubbles 40, and to use a copper film as the metal film 17, which is the object of etching. The etching device 1 of the present invention, however, is not limited to such.

That is, as the gas for forming the micro-nano bubbles 40 contained in the etching solution 5, any gases may be used as long as the zeta potential of the micro-nano bubbles 40 thereof is negative. Similarly, as the metal to form the metal film 17, any metal may be used as long as the zeta potential of the metal oxide is positive.

When a copper film is used as the metal film 17, for example, hydrogen peroxide water or a mixture of hydrofluoric acid (HF) and nitric acid (HNO₃) can be used as the etching solution 5, and as the gas for forming the micro-nano bubbles 40, air, oxygen, nitrogen, or carbon dioxide, or a mixture gas containing two or more of them can be used.

When an aluminum film is used as the metal film 17, a mixture of hydrofluoric acid and nitric acid or a mixture of acetic acid (CH₃COOH) and nitric acid can be used as the etching solution 5, and as the gas for forming the micro-nano bubbles 40, air, oxygen, nitrogen, or carbon dioxide, or a mixture gas containing two or more of them can be used.

When a titanium film is used as the metal film 17, a mixture of hydrofluoric acid, nitric acid, and perchloric acid (HClO₄) or a mixture of hydrofluoric acid, nitric acid, and ammonium persulphate (NH₄SO₄) can be used as the etching solution 5, and as the gas for forming the micro-nano bubbles 40, air, oxygen, nitrogen, or carbon dioxide, or a mixture gas containing two or more of them can be used.

### INDUSTRIAL APPLICABILITY

As described above, the present invention is useful for an etching method of etching an object to be processed having a metal film formed thereon by using an etching solution, and the etching device.

### DESCRIPTION OF REFERENCE CHARACTERS

1 etching device
2 etching solution generation unit
3 spray nozzle
4 substrate
5 etching solution
7 holder
17 metal film
30 metal oxide film
36 nozzle header
40 micro-nano bubble
48 object to be processed

1. An etching method of etching a metal film by spraying an etching solution to an object to be processed having the metal film formed on a surface of a substrate, comprising:
spraying the etching solution that contains gas micro-nano bubbles having negative zeta potential to remove metal oxide having positive zeta potential formed on the surface of the metal film.

2. The etching method according to claim 1, wherein the gas is air.

3. The etching method according to claim 1, wherein the etching solution is hydrogen peroxide water and the metal film is a copper film.

4. The etching method according to claim 1, wherein a diameter of the respective micro-nano bubbles is 0.01 μm or more and 100 μm or less.

5. The etching method according to claim 1, wherein the metal film is etched while the object to be processed is moved.

6. An etching device, comprising:
a generation unit that generates an etching solution containing gas micro-nano bubbles having negative zeta potential;
a nozzle header provided with a spray nozzle that sprays the etching solution supplied from the generation unit; and
a holder that supports an object to be processed having a metal film formed on a surface of a substrate such that the object to be processed faces the nozzle header,
wherein the etching solution is sprayed to the object to be processed so as to etch the metal film and so as to remove metal oxide having positive zeta potential formed on the surface of the metal film.

7. The etching device according to claim 6, wherein the gas is air.

8. The etching device according to claim 6, wherein the etching solution is hydrogen peroxide water, and the metal film is a copper film.

9. The etching device according to claim 6, wherein a diameter of the respective micro-nano bubbles is 0.01 μm or more and 100 μm or less.

10. The etching device according to claim 6, wherein the holder moves the object to be processed while maintaining a state in which the etching solution is sprayed to the object to be processed.
